(19) United States
(12) Patent Application Publication
(10) Pub. No.: US 2003/0069986 A1
(43) Pub. Date: Apr. 10, 2003

(54) Electronic marketplace system and method using optimization techniques

(76) Inventors: Lori Petrone, Dallas, TX (US); Peter C. Perialas JR., Austin, TX (US); Eric Hurley, Austin, TX (US); Edward Plumer, Georgetown, TX (US); Bijan Sayyar Rodsari, Austin, TX (US); Bruce Ferguson II, Round Rock, TX (US); Joe W. Pitts III, Dallas, TX (US)

Correspondence Address: Jeffrey C. Hood, Conley, Rose, & Tayon, P.C., P.O. Box 398, Austin, TX, 78767, US

(21) Appl. No.: 09/818,218

(22) Filed: Mar. 27, 2001

Related U.S. Application Data
(63) Continuation-in-part of application No. 09/578,162, filed on May 23, 2000.

(51) Int. Cl. G06F 15/16

(52) U.S. Cl. 709/232

(57) ABSTRACT

A system and method for optimizing transactions in an e-marketplace. An e-marketplace optimization server couples to a plurality of participant computers through a network, each of which is operated on behalf of a participant. The server hosts a site which provides the e-marketplace where goods and/or services are bought and sold among participants. The server also includes a transaction optimization program which mediates a transaction among the participants which best serves the needs of two or more of the participants. Each of the participant computers provides transaction information to the server, including constraints and/or objectives related to the transaction. The transaction optimization program uses the transaction information to produce transaction results for the participants, including an optimized transaction specifying which of the participants are included in the transaction, and the terms of the transaction, which optimizes any objectives of the included participants subject to any constraints of the included participants.

This application is a continuation-in-part of U.S. utility application Ser. No. 09/578,162 titled “SYSTEM AND METHOD FOR CONDUCTING AN ELECTRONIC MARKETPLACE USING OPTIMIZATION”, filed May 23, 2000, whose inventors were Lori Petrone, Pete Perialas, Eric Hurley, Edward Plumer, Bijan Sayyar Rodsari, and Joe W. Pitts III.

### BACKGROUND OF THE INVENTION

1. Field of the Invention

The present invention relates generally to the fields of e-commerce and optimization. More particularly, the present invention relates to optimization applied to e-marketplace operations.

2. Description of the Relevant Art

Electronic commerce has become an increasingly popular form of commerce in the United States and throughout the world. In a business-to-consumer context, electronic commerce, often referred to as e-commerce or Internet-based commerce, provides vendors and service providers the ability to greatly increase their sales channel and distribution network with minimal cost. An electronic commerce site provides a convenient and effective mechanism for potential participants to use, select and purchase goods or services in an easy and simple fashion over a computer network.

An important part of e-commerce involves business-to-business (B2B) transactions, such as trade between manufacturers and suppliers, or between retailers and wholesalers. One example of a B2B e-commerce center is an e-marketplace, where various companies in an industry compete and/or cooperate to place or fill orders for goods and/or services. One mechanism for these transactions is to have suppliers compete for manufacturers' orders in live, open, electronic auctions. This is referred to as a buyer's auction. Another mechanism, called a seller's auction, involves buyers competing for orders from sellers (suppliers).

The use of auctions to sell commodities is not a new concept. Basic commodities like wheat and fuel oil are bought and sold through auctions called futures exchanges, and have been for many years. Auction sites on the Internet are used to buy and sell standard processed materials like steel, chemicals, and plastics. The global spot market auctions provide significant savings over standard purchasing methods.

However, manufacturers typically spend far less on raw materials than they do on manufactured components, such as the individually crafted parts—the motors, gears, circuit boards, and plastic casings that producers forge into finished products such as automobiles and washing machines. These components are generally purchased on contracts that typically run three or four years, and they are not standardized. It is estimated that more than a third of manufacturing expenses goes toward purchasing industrial parts. Because of these issues, B2B auctions are increasingly used to buy and sell manufactured components.

Companies that currently offer some form of e-marketplace include FreeMarkets.com and e-steel, among others.

Generally, these B2B e-marketplaces provide a forum for participants to bid on orders. However, there is currently no known method to take into account the various objectives and/or constraints of each participant in developing a successful transaction, i.e., there is no current method or system which can optimize the transaction to serve the needs of both buyers and sellers.

Therefore, improved systems and methods for conducting e-commerce over a network are desired.

### SUMMARY OF THE INVENTION

The present invention comprises various embodiments of a system and method for optimizing transactions in an e-marketplace. In one embodiment, an e-marketplace optimization server is coupled to a plurality of participant computers through a network. Each of the participant computers may be operated by or on behalf of a participant. As used herein, the term “participant” is used to refer to one or both of a participant and a participant computer. The network may be a Local Area Network (LAN), or a Wide Area Network (WAN) such as the Internet.

In one embodiment, the e-marketplace optimization server may host a site which is operable to provide the e-marketplace. In the e-marketplace, goods and services may be bought and sold among participants. Each participant may be a buyer or a seller, or optionally a service provider, depending upon a particular transaction being conducted. The e-marketplace site may thus provide various types of transaction services, such as purchasing or selling goods or services, as well as providing various services (or allocating service providers) for items such as insurance, transportation, financing, and other aspects of a transaction. The e-marketplace may serve to facilitate the buying and selling of goods and services in any industry, including metals, wood and paper, food, manufacturing, electronics, healthcare, insurance, finance, or any other industry in which goods or services may be bought and sold.

The e-marketplace optimization server, in addition to hosting the e-marketplace site, may also be operable to provide optimization services to e-marketplace transactions. The optimization services may comprise mediating a transaction among the participants such that the desired outcome best serves the needs and/or desires of two or more of the participants. In one embodiment, the transaction may be optimized by a transaction optimization program or engine which is stored and executed on the e-marketplace optimization server.

The plurality of participant computer systems may be coupled to the server computer system over the network. Each of the participant computers may be operable to provide transaction information, also referred to as transaction requirements, to the server. For each of the plurality of participants, the transaction information may include one or more of constraints and/or objectives related to the transaction. The constraints and/or objectives may include parameter bounds, functions, algorithms, and/or models which specify each participant's transaction guidelines. In one embodiment, each participant may, at various times, modify the corresponding transaction information to reflect the participant's current transaction objectives and/or constraints. Each participant's transaction information may be sent to the e-marketplace optimization server. The e-marketplace optimization server may then execute the transaction optimization program using the transaction information from each of the plurality of participant computer systems to produce transaction results for each of the plurality of participants. After the transaction optimization program executing on the e-marketplace server has generated the transaction results, the transaction results may be sent to each of the participants over the network. In one embodiment, the transaction results may include an optimized transaction specifying which of the participants is included in the transaction, as well as the terms of the transaction.

The transaction optimization program may be executed using the transaction information from each of the participants to produce transaction results for each of the participants. The transaction results may include a set of transaction terms which specify a transaction between two or more of the participants which optimizes the objectives of the two or more participants subject to the constraints of the two or more participants.

As mentioned above, the objectives may codify the goals of a participant with regard to the transaction, such as increasing revenues or market share, decreasing inventory, minimizing cost, or any other desired outcome of the transaction. The constraints for a given participant may specify limitations which may bound the terms of an acceptable transaction for that participant, such as maximum or minimum order size, time to delivery, profit margin, total cost, or any other factor which may serve to limit transaction terms.

As noted above, constraints may be expressed not only as value bounds for parameters, but also in the form of functions or models. For example, a participant may provide a model to the e-marketplace and specify that an output of the model is to be minimized, maximized, or limited to a particular range. Thus the behavior of the model may constitute a constraint or limitation on a solution. Similarly, a model may be used to express objectives of a transaction for a participant.

In one embodiment, after the results have been provided to the participants, the participants may adjust their constraints and/or objectives and re-submit them to the transaction optimization server, initiating another round of transaction optimization. This may continue in an iterative fashion until a predetermined number of rounds have elapsed, or until the participants agree to terminate the process.

In one embodiment, the server computer system may also store an interface program which is executable to present a graphical user interface to the participant. The graphical user interface may comprise any interface mechanism whereby transaction information or results may be communicated between the participant and the transaction optimization program, such as Pavilion's e-Perfecter. Such information may include text, graphics, or audio. The interface provided by the interface program may be operable to allow communication between the participant and the transaction optimization program, such that the participant may send transaction information to the transaction optimization program, and the transaction optimization program may send results to the participant.

It should be noted that using a graphical user interface to specify transaction information is but one possible embodiment which focuses on a human participant being in the loop. In this approach the human configures the information, submits them to the market, receives, authorizes, and acts on the transaction result returned by the market. In another embodiment, the information may be configured and submitted automatically by the participant computer, i.e., a program may determine and submit the transaction information. In turn the result from the marketplace may be acted on automatically through a deal-fulfillment mechanism of the marketplace and/or the participants business software. In other words, in both approaches, optimization may be used to compute the optimal transaction, and the technique can be used in both automated and manual transaction-execution systems. Thus, the invention does not require a manual transaction execution. However, for purposes of illustration, the man-machine interface approach has been used in the following descriptions of the invention.

Typically, for a given transaction, the participants may include a plurality of buyers or sellers who compete with one another to place or fill an order for a product or service. Other participants may include insurance providers, transportation providers, financing entities, and other types of service providers to a transaction. The participants may each send their objectives and/or constraints (transaction information) to the transaction optimization program, which may execute an optimization program to generate an optimized transaction (transaction results) specifying terms of a transaction between two or more of the participants. The optimized transaction terms may include product type, order size, order schedule, transaction participants, financing terms, delivery terms, insurance terms, or any other information describing the optimized transaction.

In one embodiment, at least one participant may be a buyer and a plurality of participants may be sellers, wherein the transaction comprises a purchase by the buyer of a product from one of the plurality of sellers. In this case, the transaction results generated by the transaction optimization program may comprise selection of at least one seller from the plurality of sellers to sell the product to the buyer. This may be referred to as a buyer's market.

In another embodiment, at least one participant may be a seller and a plurality of participants may be buyers, wherein the transaction comprises a purchase by one or more of the plurality of buyers of a product from the seller. The transaction results generated by the transaction optimization program may comprise selection of at least one buyer from the plurality of buyers to buy the product from the seller. This may be referred to as a seller's market.

In yet another embodiment, a plurality of buyer participants and a plurality of seller participants may all engage in a complex transaction, such that the optimized transaction may involve a multitude of sub-transactions conducted among various buyers and sellers.

As noted above, when a buyer places an order for a product, there may be many factors related to the order besides the product specification. Such additional factors may include financial arrangements such as payment schedule and credit terms, or delivery arrangements, such as delivery schedule, selection of delivery services, and cost. These services may typically be bought and sold in their own respective e-marketplaces, such as a finance e-marketplace and a logistics e-marketplace, mentioned above. In one embodiment, these ancillary e-marketplaces may be coupled to the goods e-marketplace to provide an intermarket of goods and services, i.e., combining the goods and services of numerous industries into a single “one-stop” marketplace for a participant by adding these ancillary terms to a transaction.

### BRIEF DESCRIPTION OF THE DRAWINGS

Other objects and advantages of the invention will become apparent upon reading the following detailed description and upon reference to the accompanying drawings in which:

FIG. 1 illustrates a network system suitable for implementing an e-marketplace, according to one embodiment;

FIGS. 2a and 2b illustrate an e-marketplace with transaction optimization, according to one embodiment, wherein FIG. 2a illustrates various participants providing transaction information to the e-marketplace optimization server, and FIG. 2b illustrates various participants receiving transaction results from the e-marketplace optimization server;

FIG. 3 is a flowchart of a transaction optimization process, according to one embodiment;

FIG. 4 illustrates an e-marketplace with a participant, according to one embodiment;

FIG. 5 illustrates an e-marketplace with multiple participants, according to one embodiment;

FIG. 6 illustrates a goods e-marketplace, according to one embodiment;

FIG. 7 illustrates a goods e-marketplace networked with a plurality of other e-marketplaces, according to one embodiment; and

FIGS. 8a and 8b illustrate a system for optimizing an e-marketplace, according to one embodiment.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Incorporation by Reference

U.S. patent application Ser. No. 09/493,951, titled “System And Method For Optimization Including Cross-Record Constraints”, whose inventors are Frank D. Caruana, Pinchas Ben-Or, Abhijit Chatterjee, Timothy L. Smith, Thomas J. Traughber, Rhonda Alexander, Michael E. Niemann, Matthew M. Harris and Steven J. Waldschmidt, and filed on Jan. 28, 2000, is hereby incorporated by reference in its entirety as though fully and completely set forth herein.

U.S. patent application Ser. No. 09/493,404, titled “System And Method For Generating Inducements During E-Commerce Transactions Using An Optimization Process”, whose inventors are Edmond Herschap III, Timothy J. Magnuson, Thomas J. Traughber, and Kasey White, and filed on Jan. 28, 2000, is hereby incorporated by reference in its entirety as though fully and completely set forth herein.

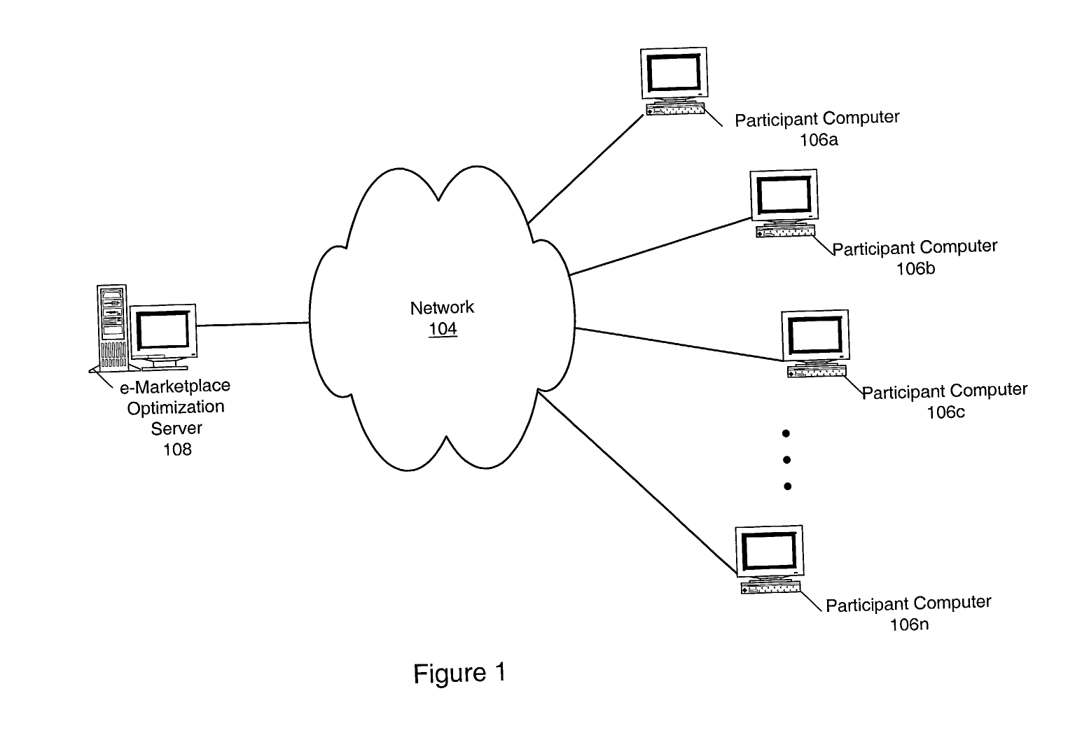

FIG. 1: An e-Marketplace System

FIG. 1 illustrates a network system suitable for implementing an e-marketplace, according to one embodiment. As FIG. 1 shows, an e-marketplace optimization server 108 is communicatively coupled to a plurality of participant computers 106 through a network 104. Each of the participant computers 106 may be operated by or on behalf of a participant. As used herein, the term “participant” is used to refer to one or both of participant and participant computer 106. The network 104 may be a Local Area Network (LAN), or a Wide Area Network (WAN) such as the Internet.

In one embodiment, the e-marketplace optimization server 108 may host an e-commerce site which is operable to provide an e-marketplace where goods and services may be bought and sold among participants 106. The e-marketplace optimization server 108 may comprise one or more server computer systems for implementing e-marketplace optimization as described herein.

Each participant 106 may be a buyer or a seller, or possibly a service provider, depending upon a particular transaction being conducted. Note that for purposes of simplicity, similar components, e.g., participant computers 106a, 106b, 106c, and 106n may be referred to collectively herein by a single reference numeral, e.g., 106.

The e-marketplace optimization server 108 preferably includes a memory medium on which computer programs according to the present invention may be stored. For example, the e-marketplace optimization server 108 may store a transaction optimization program according to one embodiment of the invention for optimizing e-marketplace transactions among a plurality of participants 106. The e-marketplace optimization server 108 may also store web site hosting software according to one embodiment of the invention for presenting various graphical user interfaces (GUIs) on the various participant computer systems 106 and for communicating with the various participant computer systems 106. The GUIs presented on the various participant computer systems 106 may be used to allow the participants to provide transaction information to the e-marketplace optimization server 108 or receive transaction results from the e-marketplace optimization server 108.

The term “memory medium” is intended to include various types of memory or storage, including a computer system memory or random access memory such as DRAM, SRAM, EDO RAM, Rambus RAM, etc., a non-volatile memory such as a magnetic media, e.g., a hard drive, or optical storage, or an installation medium, e.g., a CD-ROM, or floppy disks 104, or. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. Also, the e-marketplace optimization server 108 may take various forms, including one or more connected computer systems. In general, the term “computer system” can be broadly defined to encompass any device having a processor which executes instructions from a memory medium.

The memory medium preferably stores one or more software programs for providing an e-marketplace and optimizing transactions among various participants. The software program may be implemented in any of various ways, including procedure-based techniques, component-based techniques, and/or object-oriented techniques, among others. For example, the software program may be implemented using ActiveX controls, C++objects, Java objects, Microsoft Foundation Classes (MFC), or other technologies or methodologies, as desired. A CPU, such as the host CPU, executing code and data from the memory medium comprises a means for creating and executing the software program according to the methods or flowcharts described below.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

In the preferred embodiment, each of the participant computers 106 includes a memory medium which stores standard browser software, which is used for displaying a graphical user interface presented by the e-marketplace optimization server 108. In another embodiment, each of the participant computers 106 may store other client software for interacting with the e-marketplace optimization server 108.

The e-marketplace may serve to facilitate the buying and selling of goods and services in any industry, including metals, wood and paper, food, manufacturing, electronics, healthcare, insurance, finance, or any other industry in which goods or services may be bought and sold. In one embodiment, the e-marketplace may serve the chemical manufacturing industry, providing a forum for the purchase and sale of raw chemicals and chemical products. There may be multiple suppliers (sellers) of a given product, such as polypropylene for example, and a single buyer who wishes to place an order for the product. The multiple suppliers may compete to fill the order of the single buyer. In another embodiment, there may be multiple buyers and one supplier of a product. The multiple customers may then compete to receive an order from the supplier. In yet another embodiment, there may be multiple buyers and multiple sellers involved in a given transaction, in which case a complex transaction may result in which multiple sub-transactions may be conducted among the participants 106.

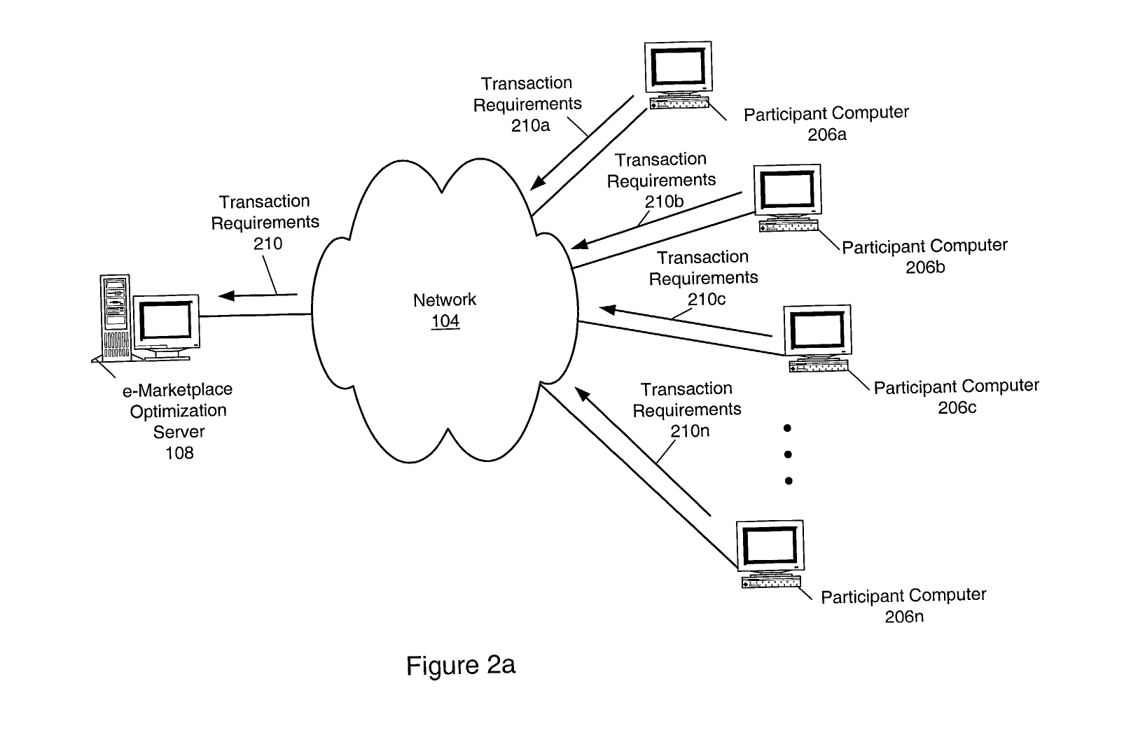

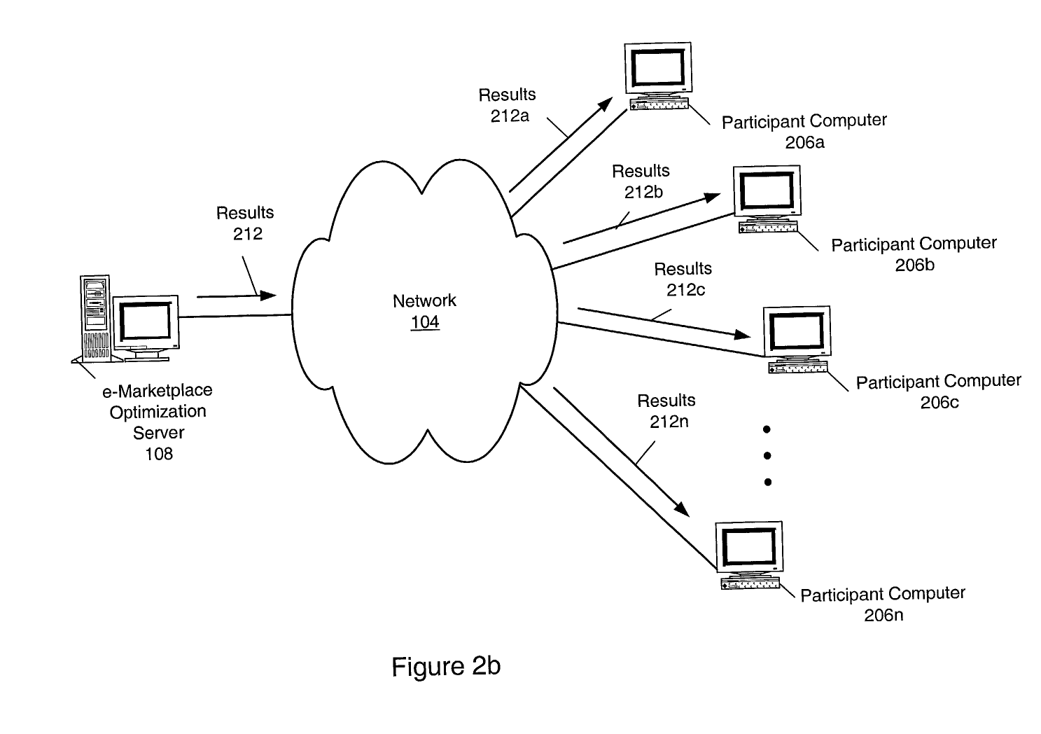

FIGS. 2a and 2b: An e-Marketplace With Transaction Optimization

FIGS. 2a and 2b illustrate an e-marketplace system with transaction optimization, according to one embodiment. As shown, the embodiments illustrated in FIGS. 2a and 2b are substantially similar to that illustrated in FIG. 1. FIG. 2a illustrates various participants 106 providing transaction information 210 to the e-marketplace optimization server 108, and FIG. 2b illustrates various participants 106 receiving transaction results from the e-marketplace optimization server 108.

The e-marketplace optimization server 108, in addition to hosting the e-marketplace site, may also be operable to provide optimization services to the e-marketplace. The optimization services may comprise mediating a transaction among the participants 106 such that the desired outcome best serves the needs and/or desires of two or more of the participants. In one embodiment, the transaction may be optimized by a transaction optimization program or engine which is stored and executed on the e-marketplace optimization server 108. For example, in the case mentioned above where there are multiple sellers and one buyer, the transaction optimization program may generate a transaction which specifies one of the sellers to provide the product order to the buyer, at a particular price, by a particular time, such that the buyer's needs are met as well as those of the seller.

As shown in FIG. 2a, the plurality of participant computer systems 106 may be coupled to the server computer system 108 over the network 104. Each of the participant computers 106 may be operable to provide transaction information 210 to the server 108. For each of the plurality of participants, the transaction information 210 may include one or more of constraints, objectives and other information related to the transaction. The constraints and/or objectives may include parameter bounds, functions, algorithms, and/or models which specify each participant's transaction guidelines. In one embodiment, each participant may, at various times, modify the corresponding transaction information 210 to reflect the participant's current transaction constraints and/or objectives. As noted above, constraints may be expressed not only as value bounds for parameters, but also in the form of functions or models. For example, a participant may provide a model to the e-marketplace and specify that an output of the model is to be minimized, maximized, or limited to a particular range. Thus the behavior of the model may constitute a constraint or limitation on a solution. Similarly, a model (or function) may also be used to express objectives of the transaction for a participant.

As FIG. 2a shows, each participant's transaction information 210 may be sent to the e-marketplace optimization server 108. The e-marketplace optimization server 108 may then execute the transaction optimization program using the transaction information 210 from each of the plurality of participant computer systems to produce optimized transaction results for each of the plurality of participants.

As shown in FIG. 2b, after the transaction optimization program executing on the e-marketplace server 108 has generated the transaction results, the transaction results may be sent to each of the participants 106 over the network 104. In one embodiment, the transaction results may specify which of the participants is included in the transaction, as well as the terms of the transaction and possibly other information.

In one embodiment, each of the participants may receive the same transaction results 212, i.e. each of the participants may receive the terms of the optimized transaction, including which of the participants were selected for the transaction. In another embodiment, each participant may receive only the transaction results 212 which apply to that participant. For example, the terms of the optimized transaction may only be delivered to those participants which were included in the optimized transaction, while the participants which were excluded from the transaction (or not selected for the transaction) may receive no results. In another embodiment, the terms of the optimized transaction may be delivered to each of the participants, but the identities of the participants selected for the optimized transaction may be concealed.

In one embodiment, the transaction optimization program may include an optimizer which operates to optimize the transaction according to the constraints and/or objectives comprised in the transaction information 210 from each of the plurality of participant computer systems 106.

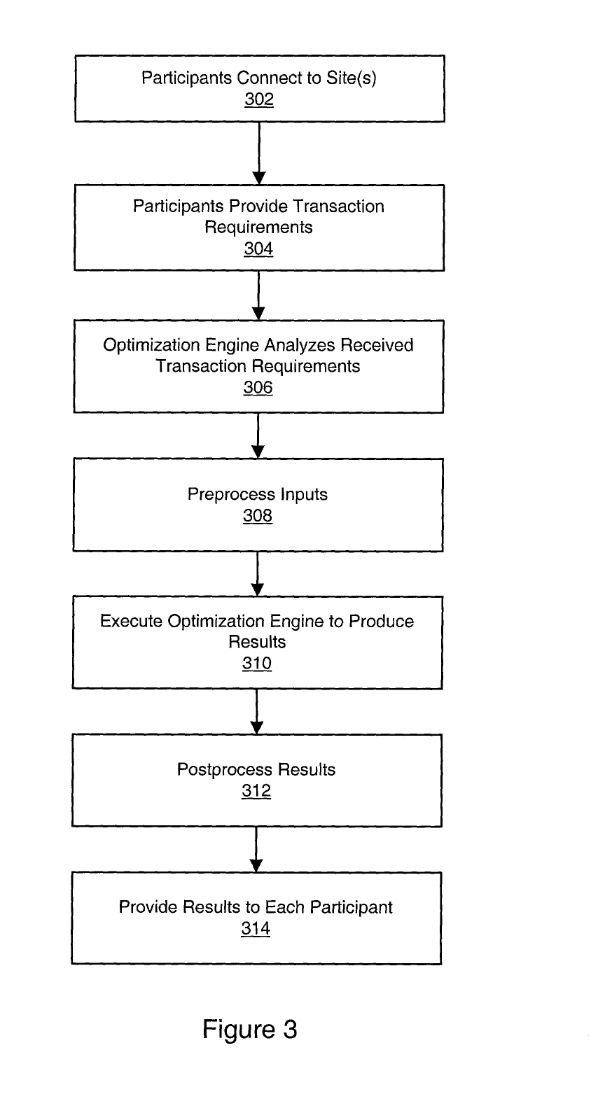

FIG. 3: Transaction Optimization Process

FIG. 3 is a flowchart of a transaction optimization process, according to one embodiment. As FIG. 3 shows, in 302, transaction participants connect to an e-marketplace site over a network 104, such as the Internet. The e-marketplace site may be hosted on e-marketplace server 108. The participants preferably connect to the e-marketplace server using participant computer systems 106 which are operable to communicate with the e-marketplace server 108 over the network 104. In one embodiment, the participants may communicate with the e-marketplace server through a web browser, such as Netscape Navigator™ or Microsoft Internet Explorer™. In another embodiment, custom client/server software may be used to communicate between the server and the participants.

In 304, the participants each provide transaction information 210 to the e-marketplace server. The transaction information 210 may include one or more constraints and/or objectives for a given participant. The objectives may codify the goals of a participant with regard to the transaction, such as increasing revenues or market share, decreasing inventory, minimizing cost, or any other desired outcome of the transaction. The constraints for a given participant may specify limitations which may bound the terms of an acceptable transaction for that participant, such as maximum or minimum order size, time to delivery, profit margin, total cost, or any other factor which may serve to limit transaction terms.

In 306, a transaction optimization engine may optionally analyze the transaction information 210 (constraints and/or objectives). In one embodiment, the transaction information 210 may be analyzed to filter out unfeasible parameters, e.g. bad data, for example, such as uninitialized or missing parameters.

In 308, the transaction optimization engine may optionally preprocess a plurality of inputs from the plurality of e-marketplace participants providing one or more transaction terms which describe the specifics of the desired transaction, such as order quantity or quality, or product type. The inputs may be preprocessed to aid in formulating the optimization problem to be solved.

In 310, the transaction optimization program may be executed using the transaction information 210 from each of the participants to produce transaction results for each of the participants. The transaction results may include a set of transaction terms which specify a transaction between two or more of the participants which optimizes the objectives of the two or more participants subject to the constraints of the two or more participants.

In 312, the transaction optimization engine may optionally post process the optimized transaction results 212. Such post processing may be performed to check for reasonable results, or to extract useful information for analysis.

Finally, in 314, the transaction results 212 are provided to the participants. At this point, the resultant optimized transaction may be executed among the two or more participants specified in the optimized transaction.

In one embodiment, after the results 212 have been provided to the participants, the participants may adjust their constraints and/or objectives and re-submit them to the transaction optimization server, initiating another round of transaction optimization. This may continue until a predetermined number of rounds has elapsed, or until the participants agree to terminate the process.

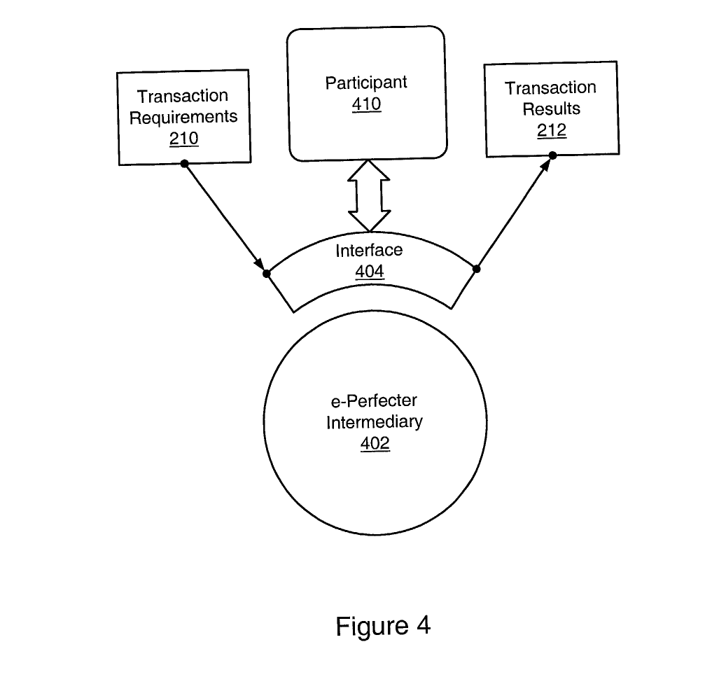

FIG. 4: e-Marketplace With Participant

FIG. 4 illustrates an e-marketplace site with a transaction optimization engine 402, such as Pavilion's e-Perfecter™, which may serve as an intermediary between various participants in a business transaction, according to one embodiment. The e-marketplace site and transaction optimization engine may be hosted on the server computer system 108, referenced in FIGS. 1 and 2, which is communicatively coupled to a participant 410 through a network. As mentioned above, the term “participant” may refer to a user, the user's computer, or both.

In one embodiment, the server computer system may also store a interface program which is executable to present a graphical user interface 404 to the participant 410. The graphical user interface 404 may comprise any interface mechanism whereby transaction information 210 or results 212 may be communicated between the participant 410 and e-Perfecter 402, such as text, graphics, or audio. The interface 404 provided by the interface program may be operable to allow communication between the participant 410 and e-Perfecter 402, such that the participant 410 may send transaction information 210 to e-Perfecter 402, and e-Perfect 402 may send results 212 to the participant 410. As shown described above, the transaction information 210 may comprise the participant's constraints and/or objectives regarding the business transaction. In one embodiment, the transaction information 210 for the participant 410 may be stored on the participant computer 410. In another embodiment, the participant's transaction information 210 may be stored on the transaction optimization server 108 which hosts e-Perfecter 402. The participant computer 410 may be further operable to receive and display the transaction results 212 sent by the transaction optimization server 108.

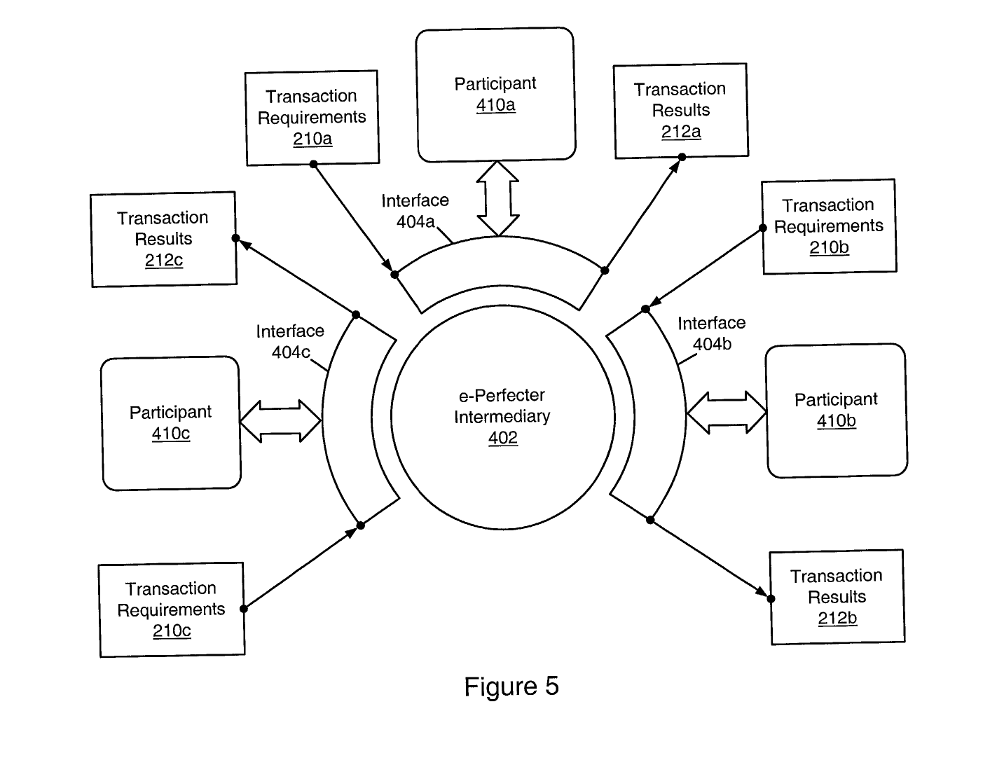

FIG. 5: e-Marketplace With Multiple Participants

FIG. 5 illustrates the e-marketplace site 402 of FIG. 4, but with a plurality of participants 410 coupled to the site. Note that although three participants 410 are shown connected to the e-marketplace site 402, this is for illustration purposes only. The number of participants 410 which may be coupled to the site 402 may be limited only by the resources available to the transaction optimization server 108 hosting the site and the site software configuration. In one embodiment, the transaction optimization server computer system 108 is operable to be coupled to a network and each of the plurality of participant computer systems 410 is also operable to be coupled to the network. In this manner, each of the participants 410 may communicate with the transaction optimization server 108.

As mentioned above, each participant 410 may connect to the server computer 108 which hosts a transaction optimization program, such as e-Perfecter 402. Each participant 410 may communicate with e-Perfecter 402 through an interface 404. As described above, each participant 410 may provide transaction information 210 to e-Perfecter 402 in the form of a set of constraints and/or objectives regarding a business transaction. The e-Perfecter system 402 may be operable to mediate an optimized transaction between two or more of the participants 410 such that the transaction is optimized to meet the transaction information 210, i.e., constraints and/or objectives, of the two or more participants, and send the terms of the optimized transaction to each of the participants 410 in the form of transaction results 212.

Typically, for a given transaction, the participants 410 may include a plurality of buyers or sellers who compete with one another to place or fill an order for a product or service. The participants 410 may each send their constraints and/or objectives (transaction information 210) to e-Perfecter, which may execute an optimization program to generate an optimized transaction (transaction result 212) specifying terms of a transaction between two or more of the participants 410. The optimized transaction terms may include product type, order size, order schedule, transaction participants, or any other information describing the optimized transaction.

In one embodiment, at least one participant may be a buyer and a plurality of participants may be sellers, wherein the transaction comprises a purchase by the at least one buyer of a product from one of the plurality of sellers. In this case, the transaction results generated by e-Perfecter may comprise selection of at least one seller from the plurality of sellers to sell the product to the at least one buyer. This may be referred to as a buyer's market.

In another embodiment, at least one participant may be a seller and a plurality of participants may be buyers, wherein the transaction comprises a purchase by one or more of the plurality of buyers of a product from the at least one seller. The transaction results generated by e-Perfecter may comprise selection of at least one buyer from the plurality of buyers to buy the product from the at least one seller. This may be referred to as a seller's market.

In yet another embodiment, a plurality of buyer participants and a plurality of seller participants may all engage in a complex transaction, such that the optimized transaction may involve a multitude of sub-transactions conducted among various buyers and sellers.

In some cases, the transaction optimization program 402 may be unable to produce transaction results 212 based on the current transaction information 210. In one embodiment, the transaction optimization program 402 may be operable to detect this condition and be executable to request new transaction information 210 from each of the plurality of participant computer systems 410. Upon reception of the new transaction information 210, the transaction optimization program 402 may process the new transaction information 210 and attempt to generate new transaction results 212 based on the new transaction information 210, wherein the new transaction results 212 comprise a new optimized transaction based upon the new constraints and/or objectives comprised in the new transaction information 210.

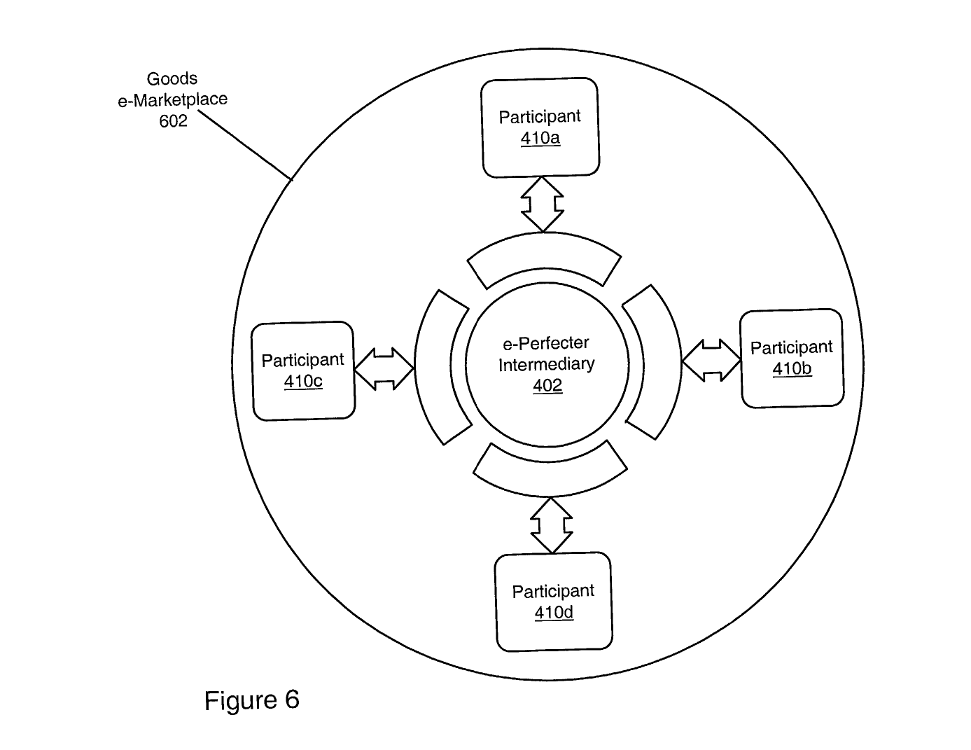

FIG. 6: A Goods e-Marketplace

FIG. 6 is an illustration of an e-marketplace suitable for buying and selling goods over a network among a plurality of participants, according to one embodiment. As FIG. 6 shows, a plurality of participants 410 may be communicatively coupled to a transaction optimization program, such as e-Perfecter 402, which may be hosted on e-marketplace optimization server 108, referenced in FIGS. 1 and 2.

The e-marketplace 602 may comprise a forum to facilitate optimized transactions between the participants 410 in a variety of industries such as chemical products and services, paper products and services, insurance, financial products and services, agricultural products, electronics, automotive products, or any other industry where goods or services may be bought and sold.

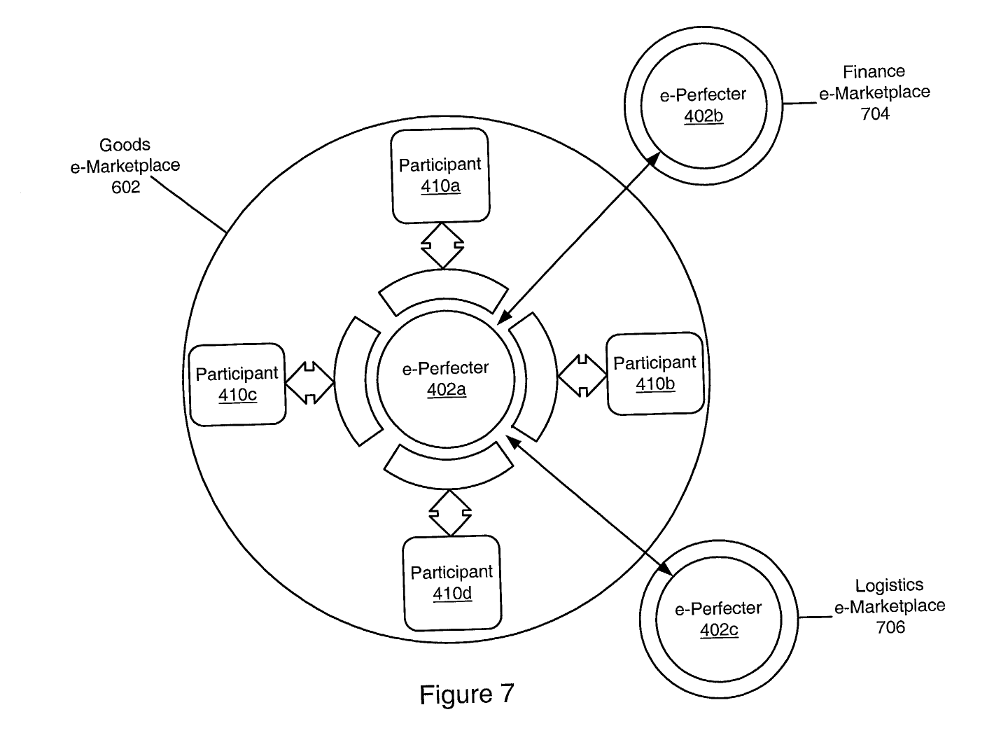

FIG. 7: A Network of e-Marketplaces

FIG. 7 illustrates the goods e-marketplace of FIG. 6 networked to various other e-marketplaces, according to one embodiment. As FIG. 7 shows, goods e-marketplace 602, described in detail above with reference to FIGS. 1-6, may be coupled to a finance e-marketplace 704 and a logistics e-marketplace 706. As shown, the finance e-marketplace 704 and the logistics e-marketplace 706 may each use the e-Perfecter transaction optimization program 402 to provide transaction optimization among the participants of each e-marketplace.

When a customer places an order for a product, there may be many factors related to the order besides the product specification. Such additional factors may include financial arrangements such as payment schedule and credit terms, or delivery arrangements, such as delivery schedule, selection of delivery services, and cost. These services may typically be bought and sold in their own respective e-marketplaces, such as the finance e-marketplace 704 and the logistics e-marketplace 706, mentioned above. In one embodiment, these ancillary e-marketplaces may be coupled to the goods e-marketplace 602 to provide an intermarket of goods and services, i.e., combining the goods and services of numerous industries into a single “one-stop” marketplace for a customer.

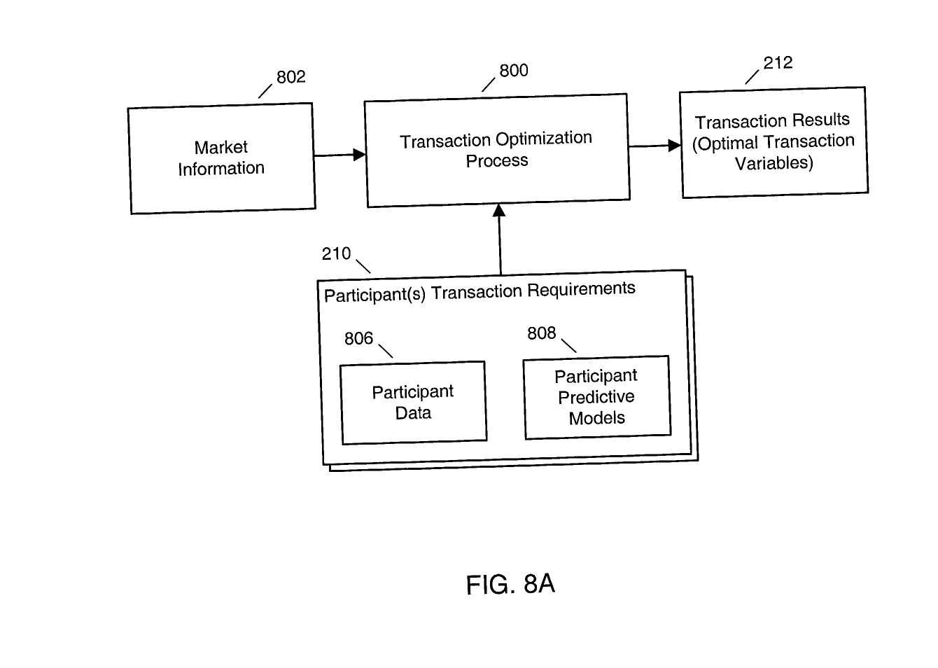

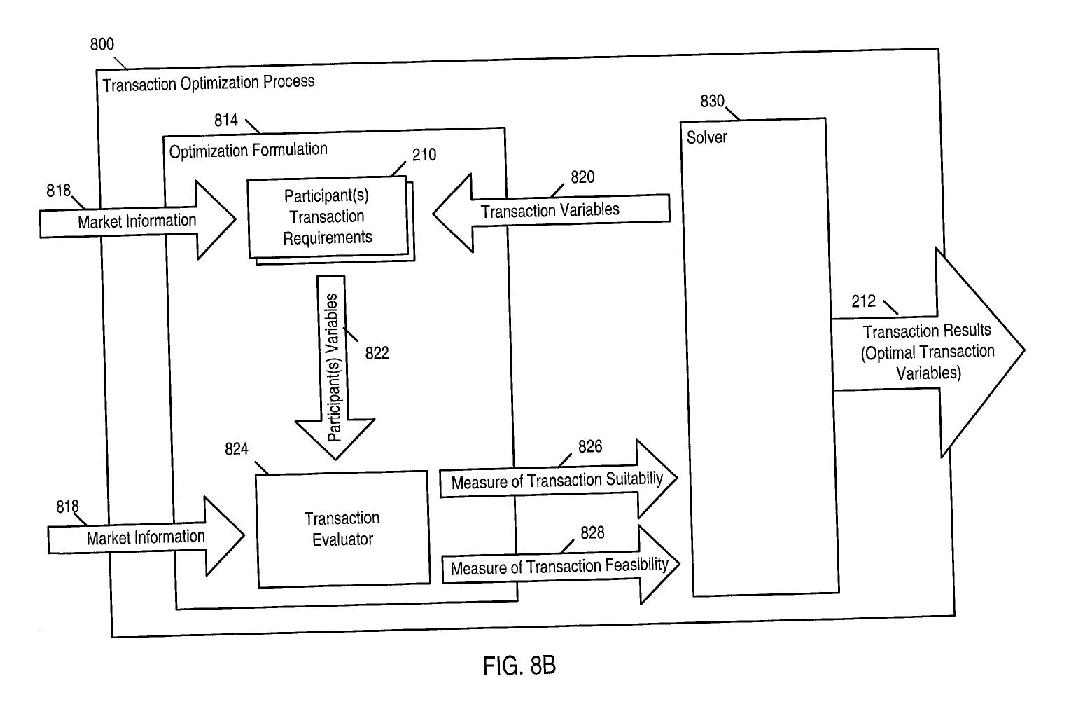

FIG. 8: Optimization Overview

FIG. 8a is a block diagram which illustrates an overview of optimization according to one embodiment. FIG. 8b is a dataflow diagram which illustrates an optimization process according to one embodiment. FIGS. 8a and 8b together illustrate an exemplary system for optimizing an e-marketplace system. While FIGS. 8a and 8b show a preferred embodiment of an optimization system, various other embodiments may be suitable for implementing the invention.

As shown in FIG. 8a, an optimization process 800 may accept the following elements as input: market information 802 and participant(s) transaction information 210. The optimization process 800 may produce as output transaction results 212 in the form of an optimized set of transaction variables. As used herein, “optimized” means that the selection of transaction values is based on a numerical search or selection process which maximizes a measure of suitability while satisfying a set of feasibility constraints. A further understanding of the optimization process 800 may be gained from the references “An Introduction to Management Science: Quantitative Approaches to Decision Making”, by David R. Anderson, Dennis J. Sweeney, and Thomas A. Williams, West Publishing Co. (1991); and “Fundamentals of Management Science” by Efraim Turban and Jack R. Meredith, Business Publications, Inc. (1988).

As used herein, the term “market information” may refer to any information generated, stored, or computed by the marketplace which provides context for the possible transactions. This information is not available to a participant without engaging in the e-market place. Furthermore, the market information is treated as a set of external variables in that those variables are not under the control of the transaction optimization process. For example, the market-place might report the number of active participants, the recent historical demand for a particular product, or the current asking price for a product being sold. Additionally, market information may include information retrieved from other marketplaces.

As used herein, “transaction information” may include information that a participant provides to the optimization process to affect the outcome of the transaction optimization process. This information may include: (a) the participants objectives in accepting a transaction, (b) constraints describing what transaction parameters the participant will accept, (c) and internal participant data including inventory, production schedules, cost of goods sold, available funds, and/or required delivery times. Information can either be specified statically as participant data 806 or as participant predictive models 808 which allow information to be computed dynamically based on market information and transaction variables

As used herein, an “objective” may include a goal or desired outcome of a transaction optimization process. Some example objectives are: obtain goods at a minimum price, sell goods in large lots, minimize delivery costs, and reduce inventory as rapidly as possible.

As used herein, a “constraint” may include a limitation on the outcome of an optimization process. Constraints may include “real-world” limits on the transaction variables and are often critical to the feasibility of any optimization solution. For example, a market-place seller may impose a minimum constraint on the volume of product that can be delivered in one transaction. A market-place buy may have a maximum price on a purchased product. Constraints may not be limited to transaction variables, but may be also be constraints of computed variables. For example, a seller may have a minimum limit on the margin of sales. This quantity is computed internally by the seller participant. Constraints may reflect financial or business constraints. They may also reflect physical production or delivery constraints.

As described above, the constraints and/or objectives provided by a participant may include parameter bounds or limits, functions, algorithms, and/or models which express the desired transaction information of the participant.

As used herein, “transaction variables” define the terms of a transaction. For example, the transaction variables might identify the selected participants, the volume of product exchanged, the purchase price, and the delivery terms. As used herein, “optimal transaction variables” define the final transaction, which is provided to two or more of the participants as transaction results 212. The optimization process 800 selects the optimal transaction variables in order to satisfy the constraints of the participants and best meet the objectives of the participants.

As shown in the dataflow of FIG. 8b, the transaction optimization process consists of an optimization formulation 814 and a solver 830. The optimization formulation is a system which may take as input a proposed set of transaction variables 820 and market information 818. The optimization formulation computes both a measure of suitability for the proposed transaction 826 and one or more measures of feasibility for the proposed transaction 828. The solver determines a set of transaction variables that maximizes the transaction suitability over all participants while simultaneously ensuring that all of the transaction feasibility conditions are satisfied.

Before execution of the transaction optimization program, participants may each submit transaction information 210 to the marketplace. This information is incorporated into the optimization formulation 814. The participant transaction information 210 is used to compute or specify a set of participant variables 822 for each participant based on the market information 818, proposed transaction variables 820, and participant's unique properties. The participant variables are passed to a transaction evaluator 824 which determines the overall suitability 826 and feasibility 828 of the transaction variables 820 proposed by the solver. The solver uses these measure to refine the choice of transaction variables. After the optimization solver computes, selects, or creates the final set of transaction variables in response to the received data, the e-marketplace server, or a separate server, thereby producing transaction results 212 for the participants. The solver then provides the transaction results 212 to some or all of the participants. The transaction results 212 are provided to the client systems of the participants, where the results (transactions) are displayed, stored or automatically acted on. As discussed above, the transaction results 212 are preferably designed to achieve a desired commercial result, e.g., to complete a transaction in a desired way, such as by purchasing or selling a product.

Participant variables 822 are used to represent participant constraints and/or objectives to the transaction evaluator in a standard form. These variables are based on the participant's transaction information. In one embodiment, the constraints and/or objectives are directly represented as participant data. For example, a buyer-participant may specify a product code, desired volume, and maximum unit price. In another example a seller may specify available product, minimum selling price, minimum order volume, and delivery time-window. In another embodiment, objective and constraint terms are computed as a function of transaction variables using predictive models. For example, a buyer may specify a maximum price computed based on a combination of the predicted market demand and seller's available volume. As another example, models may be used to translate a participant's strategic business objectives such as increase profit, increase market share, minimized inventory, etc., into standardized objective and constraint information based on current marketplace activity. In yet another embodiment, constraints and/or objectives are determined as a mixture of static data and dynamically computed values.

Predictive model(s) 808 are used to compute participant variables such as constraints and/or objectives dynamically based on current marketplace information and proposed transaction variables. Models may estimate current or future values associated with the participant, other participants, or market conditions. Computations may represent different aspects of a participant's strategy. For example, a predictive model may represent the manufacturing conditions and behavior of a participant, a price-bidding strategy, the future state of a participant's product inventory, or the future behavior of other participants.

Predictive models 808 may take on any of a number of forms. In one embodiment, a model may be implemented as a neural network. Typically, the neural network may include a layer of input nodes, interconnected to a layer of hidden nodes, which are in turn interconnected to a layer of output nodes, wherein each connection is associated with an adjustable weight and wherein each node computes a non-linear function of values of source nodes. The adjustable parameters are set in the training phase of the model. The neural network may be trained based on data extracted from historical archives, data gathered from designed experiments, or data gathered during the course of transaction negotiations. The neural network might be further trained based on dynamic marketplace information. In another embodiment, predictive models are based on statistical regression methods. In another embodiment, predictive models are based on analytical formulas. In another embodiment, predictive models are based on physical first principles. In another embodiment, the predictive models are based on rule-based systems or decision-tree logic. In another embodiment, a model may be implemented as an aggregation of a plurality of model types.

Individual constraints and/or objectives 822 from two or more participants are passed to the transaction evaluator 824. The transaction evaluator combines the set of participant constraints to provide to the solver 830 one or more measures of transaction feasibility 828. The transaction evaluator also combines the individual objectives of the participants to provide to the solver 830 one or more measures of transaction suitability 826. The combination of objectives may be based on a number of different strategies. In one embodiment, the individual objectives levels may be combined by a weighted average. In a different embodiment, the individual objectives may be preserved and simultaneously optimized such as in a Pareto optimal sense.

The solver 830 implements a constrained search strategy to determine the set of transaction variables that maximize the transaction suitability while satisfying the transaction feasibility constraints. Many strategies may be used and this invention allows solver strategies to be substituted as necessary to satisfy the requirements of a particular marketplace type. Examples of search strategies include gradient-based solvers such as linear programming, non-linear programming, mixed-integer linear and non-linear programming. Search strategies may also include non-gradient methods such as genetic algorithms and evolutionary programming techniques. Solvers may be implemented as custom optimization processes or off-the-shelf applications or libraries.

For more information on one embodiment of an optimization process for an e-marketplace see U.S. patent application Ser. No. 09/493,951, titled “System And Method For Optimization Including Cross-Record Constraints”, filed on Jan. 28, 2000 and U.S. patent application Ser. No. 09/493,404, titled “System And Method For Generating Inducements During E-Commerce Transactions Using An Optimization Process”, filed on Jan. 28, 2000, which are both hereby incorporated by reference.

While the present invention has been described with reference to particular embodiments, it will be understood that the embodiments are illustrated and that the invention scope is not so limited. Any variations, modifications, additions and improvements to the embodiments described are possible. These variations, modifications, additions and improvements may fall within the scope of the invention as detailed within the following claims.

What is claimed is:

1. A system for optimizing a transaction among a plurality of participants, the system comprising:
a server computer system which includes a processor and a memory medium, wherein the memory medium of the server computer system stores a transaction optimization program for optimizing the transaction among the plurality of participants in the transaction; and
a plurality of participant computer systems operable to be coupled to the server computer system, wherein each of the plurality of participant computer systems is operated by one of the plurality of participants, wherein each of the plurality of participant computer systems is operable to provide transaction information to the server computer system, wherein, for each of the plurality of participants, the transaction information includes one or more of constraints and objectives related to the transaction;
wherein the server computer system is operable to execute the transaction optimization program using the transaction information from each of the plurality of participant computer systems to produce transaction results for each of the plurality of participants.

2. The system of claim 1,
wherein the transaction optimization program is executable to receive the transaction information from each of the plurality of participant computer systems; and
wherein the transaction optimization program includes or is coupled to an optimizer which operates to optimize the transaction according to one or more of the constraints and objectives comprised in the transaction information from each of the plurality of participant computer systems.

3. The system of claim 1, wherein the transaction information of each participant are stored on the participant computer system.

4. The system of claim 1, wherein the transaction information of each participant are stored on the server computer system.

5. The system of claim 1,
wherein the system functions as an e-marketplace, wherein the e-marketplace comprises a forum to facilitate transactions between the participants, and wherein the e-marketplace comprises an e-commerce site hosted on an e-commerce server computer system.

6. The system of claim 5,
wherein the transaction optimization program includes a model of the e-marketplace, and wherein the transaction optimization program uses the model of the e-marketplace to predict transaction results for each of the participants.

7. The system of claim 1,
wherein the server computer system is operable to provide the transaction results to each of the plurality of participant computer systems; and
wherein each of the plurality of participant computer systems is operable to receive and display the transaction results.

8. The system of claim 1,
wherein the memory medium of the server computer system also stores an interface program, wherein the interface program is executable to present a graphical user interface to each of the plurality of participant computer systems; and
wherein each of the plurality of participant computer systems is operable to input the transaction information using the graphical user interface provided by the interface program.

9. The system of claim 1,
wherein at least one participant is a buyer and a plurality of participants are sellers, wherein the transaction comprises a purchase by the at least one buyer of a product from one of the plurality of sellers; and
wherein the transaction results comprise selection of at least one seller from the plurality of sellers to sell the product to the at least one buyer.

10. The system of claim 1,
wherein at least one participant is a seller and a plurality of participants are buyers, wherein the transaction comprises a purchase by one or more of the plurality of buyers of a product from the at least one seller; and
wherein the transaction results comprise selection of at least one buyer from the plurality of buyers to buy the product from the at least one seller.

11. The system of claim 1,
wherein the transaction optimization program is executable to request new transaction information from each of the plurality of participant computer systems in response to determining that the transaction optimization program is not able to produce transaction results based on the current transaction information.

12. The system of claim 1,
wherein the server computer system is operable to be coupled to a network; and
wherein each of the plurality of participant computer systems is operable to be coupled to the network.

13. The system of claim 1,
wherein the system functions as an e-marketplace, wherein the e-marketplace comprises a forum to facilitate transactions between the participants, and wherein the e-marketplace comprises an e-commerce site hosted on an e-commerce server computer system.

14. The system of claim 13,
wherein the transactions comprise buying and selling of chemical products and services.

15. The system of claim 13,
wherein the transactions comprise buying and selling of paper products and services.

16. The system of claim 13,
wherein the transactions comprise buying and selling of insurance products and services.

17. The system of claim 13,
wherein the transactions comprise buying and selling of financial products and services.

18. The system of claim 13,
wherein the transactions comprise buying and selling of metal products and services.

19. The system of claim 1,
wherein each of the plurality of participant computer systems is operable to adjust its transaction information and re-submit the adjusted transaction information to the server after receiving the transaction results;
wherein the transaction optimization program is executable to receive the adjusted transaction information from each of the plurality of participant computer systems; and
wherein the transaction optimization program operates to optimize the transaction according to one or more of the constraints and objectives comprised in the adjusted transaction information from each of the plurality of participant computer systems.

20. A system for optimizing a transaction among a plurality of participants, the system comprising:
a processor; and
an input for coupling to a network, wherein the input is operable to receive transaction information from the plurality of participants, wherein, for each of the plurality of participants, the transaction information includes one or more of constraints and objectives related to the transaction; and
a memory medium coupled to the processor, wherein the memory medium stores a transaction optimization program for optimizing transactions among the plurality of participants in the transaction, wherein the memory medium is also operable to receive and store the transaction information from the plurality of participants;
wherein the processor is operable to execute the transaction optimization program using the transaction information from each of the plurality of participants to produce transaction results for each of the plurality of participants.

21. The system of claim 20,
wherein the transaction optimization program includes an optimizer which operates to optimize the transaction according to one or more of the constraints and objectives comprised in the transaction information from each of the plurality of participants.

22. The system of claim 20,
wherein the system functions as an e-marketplace, wherein the e-marketplace comprises a forum to facilitate transactions between the participants, and wherein the e-marketplace comprises an e-commerce site hosted on an e-commerce server computer system.

23. The system of claim 22,
wherein the transaction optimization program includes a model of the e-marketplace, and wherein the transaction optimization program uses the model of the e-marketplace to predict transaction results for each of the participants.

24. The system of claim 20, further comprising an output for coupling to the network, wherein the output is operable to provide the transaction results to each of the plurality of participants.

25. The system of claim 20,
wherein the memory medium also stores an interface program, wherein the interface program is executable to present a graphical user interface to each of the plurality of participants; and
wherein the graphical user interface provided by the interface program is operable to accept the transaction information from each of the plurality of participants.

26. The system of claim 20,
wherein at least one participant is a buyer and a plurality of participants are sellers, wherein the transaction comprises a purchase by the at least one buyer of a product from one of the plurality of sellers; and
wherein the transaction results comprise selection of at least one seller from the plurality of sellers to sell the product to the at least one buyer.

27. The system of claim 20,
wherein at least one participant is a seller and a plurality of participants are buyers, wherein the transaction comprises a purchase by one or more of the plurality of buyers of a product from the at least one seller; and
wherein the transaction results comprise selection of at least one buyer from the plurality of buyers to buy the product from the at least one seller.

28. The system of claim 20,
wherein the transaction optimization program is executable to request new transaction information from each of the plurality of participants in response to determining that the transaction optimization program is not able to produce transaction results based on the current transaction information.

29. The system of claim 20,
wherein the transactions comprise buying and selling of chemical products and services.

30. The system of claim 20,
wherein the transactions comprise buying and selling of paper products and services.

31. The system of claim 20,
wherein the transactions comprise buying and selling of insurance products and services.

32. The system of claim 20,
wherein the transactions comprise buying and selling of financial products and services.

33. The system of claim 20,
wherein the transactions comprise buying and selling of metal products and services.

34. The system of claim 20,
wherein the input is further operable to receive adjusted transaction information from each of the plurality of participants after the transaction results have been provided to the each of the plurality of participants, wherein the transaction optimization program operates to optimize the transaction according to one or more of the constraints and objectives comprised in the adjusted transaction information from each of the plurality of participants.

35. The system of claim 20, wherein the transaction information of each participant are stored on a participant computer system, wherein for each participant, the participant computer system is operated by or on behalf of the participant.

36. The system of claim 20, wherein the transaction information of each participant are stored on the server computer system.

37. A method for optimizing transactions among a plurality of participants, the method comprising:
receiving transaction information from each of the plurality of participants in the transaction, wherein, for each of the plurality of participants, the transaction information includes one or more of constraints and objectives related to the transaction;
executing a transaction optimization program using the transaction information from each of the plurality of participants to produce transaction results for each of the plurality of participants; and
providing the transaction results to the plurality of participants.

38. The method of claim 37,
wherein the executing the transaction optimization program includes executing an optimizer which operates to optimize the transaction according to one or more of the constraints and objectives comprised in the transaction information from each of the plurality of participants.

39. The method of claim 38,
wherein the method implements an e-marketplace, wherein the e-marketplace comprises a forum to facilitate transactions between the participants, and wherein the e-marketplace comprises an e-commerce site hosted on an e-commerce server computer system.

40. The method of claim 39,
wherein the executing the transaction optimization program includes executing a model of the e-marketplace, and wherein the transaction optimization program uses the model of the e-marketplace to predict transaction results for each of the participants.

41. The method of claim 39, further comprising executing an interface program to present a graphical user interface to each of the plurality of participants;
wherein the graphical user interface provided by the interface program is operable to accept the transaction information from each of the plurality of participants.

42. The method of claim 39,
wherein at least one participant is a buyer and a plurality of participants are sellers, wherein the transaction comprises a purchase by the at least one buyer of a product from one of the plurality of sellers; and
wherein the transaction results comprise selection of at least one seller from the plurality of sellers to sell the product to the at least one buyer.

43. The method of claim 39,
wherein at least one participant is a seller and a plurality of participants are buyers, wherein the transaction comprises a purchase by one or more of the plurality of buyers of a product from the at least one seller; and
wherein the transaction results comprise selection of at least one buyer from the plurality of buyers to buy the product from the at least one seller.

44. The method of claim 39,
wherein executing the transaction optimization program further comprises requesting new transaction information from each of the plurality of participants in response to determining that the transaction optimization program is not able to produce transaction results based on the received transaction information.

45. The method of claim 39,
wherein the method implements an e-marketplace, wherein the e-marketplace comprises a forum to facilitate transactions between the participants, and wherein the e-marketplace comprises an e-commerce site hosted on an e-commerce server computer system.

46. The system of claim 45,
wherein the transactions comprise buying and selling of chemical products and services.

47. The system of claim 45,
wherein the transactions comprise buying and selling of paper products and services.

48. The system of claim 45,
wherein the transactions comprise buying and selling of insurance products and services.

49. The system of claim 45,
wherein the transactions comprise buying and selling of financial products and services.

50. The method of claim 39, further comprising:
receiving adjusted transaction information from each of the plurality of participants after the providing the transaction results to the plurality of participants, wherein, for each of the plurality of participants, the adjusted transaction information includes one or more of adjusted constraints and adjusted objectives related to the transaction;
executing the transaction optimization program using the adjusted transaction information from each of the plurality of participants to produce adjusted transaction results for each of the plurality of participants; and
providing the adjusted transaction results to the plurality of participants.

51. The method of claim 39, wherein the transaction information of each participant are stored on a participant computer system, wherein for each participant, the participant computer system is operated by or on behalf of the participant.

52. The method of claim 39, further comprising storing the transaction information of each participant on the server computer system.
